(19) United States
(12) Patent Application Publication
(10) Pub. No.: US 2007/0092599 A1
(43) Pub. Date: Apr. 26, 2007

(54) Method of increasing free glutamic acid content in meat and feed therefor

(75) Inventors: Shinobu Fujimura, Niigata-shi (JP); Motoni Kadowaki, Niigata-shi (JP); Mai Imanari, Minamiuonuma-gun (JP)

Correspondence Address: BIRCH STEWART KOLASCH & BIRCH, PO BOX 747, FALLS CHURCH, VA, 22040-0747, US

(73) Assignee: Niigata TLo Corporation, Niigata (JP)

(21) Appl. No.: 10/568,782

(22) PCT Filed: Mar. 19, 2004
(86) PCT No.: PCT/JP04/03757

§ 371 Date: Aug. 16, 2006

(30) Foreign Application Priority Data
Aug. 22, 2003 (JP) 2003-208474

(51) Int. Cl. A23K 1/18

(52) U.S. Cl. 426/2

(57) ABSTRACT

A method for increasing free glutamic acid content in meat of poultry or livestock, thereby improving the taste of the meat, and the feed used therefor are disclosed. In the method of the present invention, a feed having a low leucine content is given to the poultry or livestock.

### TECHNICAL FIELD

The present invention relates to a method for increasing free glutamic acid in meat of poultry or livestock.

### BACKGROUND ART

Conventional poultry feeds are so designed as to attain sufficient performance at a low cost, using productivities such as increase in body weight and feed efficiency as main indices. Nutrition requirements are employed as a part of the standards therefor and the content of each nutrient is set to a level sufficiently exceeding each nutrition requirement. According to the Nutrient Requirement of Poultry, 1994, of the U.S. NRC, the nutrition requirement of leucine which is an essential amino acid is set to 1.09% for poultry of 3 to 6 weeks old and to 0.93% for poultry of 6 to 8 weeks old, and these contents are used as the standards of leucine requirement worldwide. According to Japanese Nutrient Requirement of Poultry (1997), the leucine requirement for poultry of not younger than 3 weeks old is set to 1.06%.

As mentioned above, in the current feeds using the productivities (growth rate, feed efficiency and the like) as main indices, it is demanded that the leucine content sufficiently exceed the requirement, and an idea to set the leucine content equal to the requirement or to a level little smaller than the requirement is not employed.

In the conventional formula feeds comprising maize and soybean cake as main ingredients, which are generally used in Japan and the U.S., leucine is much contained, and the leucine contents therein are about 1.3 to 1.5 times the requirement (1.09%).

### DISCLOSURE OF THE INVENTION

In the prior art mentioned above, the amino acid ratios in the feed are set so as to sufficiently exceed the nutrition requirements. In the conventional feeds, no attention is paid to the change in the free glutamic acid content in the meat, and the contents of amino acids are set employing as indices the cost, growth and feed efficiency.

To attain high quality of meat, adjustment of free glutamic acid content in the meat, which is one of the taste components, is very effective. However, there is no knowledge for increasing the free glutamic acid in the meat by the feed, and there is no idea to increase the free glutamic acid content by leucine in designing the feed.

An object of the present invention is to provide a feed for producing meat containing much taste components in the meat and having good taste. Another object of the present invention is to improve the quality of the meat, especially the taste of the meat. For attaining this object, the free glutamic acid which is the major taste component of meat is increased by strictly setting the content of leucine that is one of the amino acids contained in the feed itself.

That is, an object of the present invention is to provide a method for increasing the free glutamic acid content in the meat of poultry or livestock, thereby improving the taste of the meat. Another object of the present invention is to provide a feed used for the above-mentioned method according to the present invention.

The present inventors intensively studied to discover that the free glutamic acid content in the meat can be increased by giving to the poultry or livestock a feed with a low leucine content, thereby completing the present invention.

That is, the present invention provides a method for increasing free glutamic acid content in meat of poultry or livestock, which method comprises giving the poultry or the livestock a feed having a low leucine content. The present invention also provides a feed having a low leucine content, used for the above-mentioned method of the present invention.

According to the present invention, contrary to the conventional concept, the free glutamic acid content in the meat can be increased by setting the leucine content to a level less than the requirement. The meat produced by this method was distinguished as having significantly good taste by sensory evaluation by human gustation. Therefore, in addition to the improvement of taste of the meat, a secondary effect that the amounts of the chemical seasonings used are decreased, so that the feed can be used in practice.

### BRIEF DESCRIPTION OF THE DRAWINGS

FIG. 1 shows the relationship between the leucine content in the feed and the free glutamic acid level in the muscle.

FIG. 2 shows the results of sensory evaluation for testing whether there is a difference in taste between the meat of chickens, having a free glutamic acid level increased by the method of the present invention and the meat of chickens raised by a conventional method.

FIG. 3 shows the results of the sensory evaluation for examining the characteristics of the taste of the meat of chickens, having a free glutamic acid level increased by the method of the present invention in comparison with the taste of the meat of chickens raised by a conventional method.

FIG. 4 shows the relationship between the leucine content in the feed having a high protein content and the free glutamic acid level in the muscle, when feeds having different leucine contents were given.

FIG. 5 shows the results of sensory evaluation for testing whether there is a difference in taste between the meat of chickens, having a free glutamic acid level increased by the method of the present invention when using a feed having a high protein content was used and the meat of chickens raised by a conventional method.

FIG. 6 shows the results of the sensory evaluation for examining the characteristics of the taste of the meat of chickens, having a free glutamic acid level increased by the method of the present invention using a feed having a high protein content, in comparison with the taste of the meat of chickens raised by a conventional method.

FIG. 7 shows the mechanism of adjustment in animal body, according to which the free glutamic acid level is increased by the method of the present invention.

FIG. 8 shows the enzyme activity of glutamate dehydrogenase in the muscles of chickens, in which the free glutamic acid levels were increased by the method of the present invention in accordance with the adjustment mechanism shown in FIG. 7, in comparison with those in the muscles of the chickens raised by the conventional methods.

### BEST MODE FOR CARRYING OUT THE INVENTION

As mentioned above, in the method of the present invention, the leucine content in the feed is set to a level lower than the known feeds. The leucine content is not less than 70% and less than 120%, preferably not less than 70% and less than 108%, more preferably not less than 70% and less than 100% of the standard leucine requirement. Thus, in case of chicken, when the age of the chicken at the time of slaughter is not younger than 3 weeks old and younger than 6 weeks old, the leucine content in the feed is preferably not less than 0.76% by weight and less than 1.30% by weight, more preferably not less than 0.76% by weight and less than 1.17% by weight, and when the age of the chicken at the time of slaughter is not younger than 6 weeks old, the leucine content is preferably not less than 0.65% by weight and less than 1.12% by weight, more preferably not less than 0.65% by weight and less than 1.02% by weight.

The method of the present invention is effective to poultry and livestock other than chicken. The leucine content is set to a level lower than the standard leucine content established for each animal, and the leucine content is preferably set to not less than 70% and less than 120%, more preferably not less than 70% and less than 108% of the standard leucine content. For example, in case of swine with a body weight of 70 kg to 115 kg, the leucine content in the feed is preferably not less than 0.39% by weight and less than 0.66% by weight, more preferably not less than 0.39% by weight and less than 0.61% by weight.

The crude protein content may be 11% by weight to 24% by weight, and in most cases 17% by weight to 24% by weight in ordinary feeds. In cases where the crude protein content in the feed is 17% by weight to 24% by weight, if the leucine content is too low, feed intake is decreased and so the growth is slowed. Therefore, in cases where the crude protein in the feed is in the range from 17% by weight to 24% by weight, the leucine content is preferably not less than 90% and less than 120%, more preferably not less than 100% and less than 108% of the standard leucine requirement.

The feed having low leucine content is preferably given at least from two days before the slaughter until immediately before the slaughter, more preferably at least from 10 days before the slaughter until immediately before the slaughter.

The leucine content in the feed can be measured as follows:

(1) Method of Hydrolysis of Proteins for Amino Acid Analysis

A sample is pulverized using a mill. The resulting powdery feed is weighed into a test tube and 6N hydrochloric acid is added, followed by hydrolysis for 22 hours in a furnace at 110° C. After the hydrolysis, the test tube is quickly removed and the hydrolyte is filtered using a suction filtration apparatus, followed by adding to the filtrate 5N sodium hydroxide solution to neutralize the filtrate. After cease of the generation of reaction heat and after returning to room temperature, quantification with distilled water is performed. The resultant was subjected to amino acid analysis by high performance liquid chromatography.

(2) Amino Acid Analysis by High Performance Liquid Chromatography

The leucine content in the feed is measured by high performance liquid chromatography. A sodium type column is used. The mobile phase is: Solution A: 0.2N sodium citrate solution (containing 7% of ethanol, pH 3.20); Solution B: 0.6N sodium citrate solution (pH 10.0) containing 0.2M boric acid; and Solution C: 0.2M sodium hydroxide solution.

The crude protein content in the feed can be measured by a conventional method such as Kjeldahl method (e.g., the method defined by AOAC (Association of Analytical Communities); Commentary on Methods of Analysis in Feeds (third edition), Society of Feed Analysis Standards eds., published by Japan Scientific Feeds Association, 1998, pp. 16-21).

The meat produced by this method was distinguished as having significantly better taste by sensory evaluation by human gustation. Thus, the taste is improved. Increase in the free glutamic acid content in the meat and, in turn, enhancement of umami enables to decrease the amount of chemical seasonings used in cooking or even to eliminate the use of chemical seasonings. Thus, the meat produced by this method also meets the recent trend to attach importance to the natural food materials and to decrease the amounts of chemical seasonings used.

Although the leucine content is set to a low level in the method of the present invention, the same effect may be attained physiologically under the conditions described below by utilizing the imbalance even when the leucine content is high. That is, the meat having a high glutamic acid content in the muscle and having strong umami taste may be produced by the method described below.

Leucine is an amino acid metabolized in the muscle, and so the leucine taken from the feed is not metabolized in the liver of animals, but used in the muscles.

Isoleucine and Valine are also the amino acids metabolized in muscles, and it is known that leucine, isoleucine and valine interact each other. Even if the leucine content in the feed is not less than 1.090% by weight, by giving excess amount of isoleucine and/or valine, the same physiological conditions attained by the low leucine content of 0.76% according to the present invention may be attained. By this, the glutamic acid content in the meat is increased, which is another mode of the present invention.

This effect is also obtained not only in poultry but also in livestock such as swine.

Leucine is also known as an amino acid which represses decomposition of proteins in the animal body. Thus, by increase of leucine, decomposition of proteins is repressed. When the leucine content is high, the decomposition of proteins into glutamic acid is repressed, so that the glutamic acid level in the meat is reduced to a low level. Amino acids having the decomposition-repressing effect as leucine include tyrosine, glutamine, proline, methionine, histidine and tryptophan. Among these, essential amino acids which cannot be synthesized in the body and must be taken from the feed are methionine, histidine and tryptophan. Thus, by decreasing the contents of these amino acids, it is thought that the effect to repress decomposition of proteins is reduced and so the glutamic acid content in the meat is increased.

This effect is also obtained not only in poultry but also in livestock such as swine.

The present invention will now be described by way of examples thereof. It should be noted, however, the present invention is not restricted to the examples below. In the following examples and comparative examples, all % are by weight unless otherwise specified.

### EXAMPLES 1 AND 2, COMPARATIVE EXAMPLES 1 AND 2

To each group of chickens consisting of 12 chickens per group, Feed 1 (Example 1), Feed 2 (Example 2), Feed 3 (Comparative Example 1) or Feed 4 (Comparative Example 2) was continuously given for 10 days from 4 weeks of age to immediately before the slaughter. The leucine contents of Feed 1, Feed 2, Feed 3 and Feed 4 were 0.76% by weight, 1.09% by weight, 1.42% by weight and 1.64% by weight, respectively. The composition of each feed is shown below.

Feed 1: maize 75.7%, wheat bran 0.7%, soybean oil 5.5%, calcium carbonate 1.4%, calcium hydrogen phosphate 1.7%, sodium chloride 0.3%, vitamin-mineral mixture 0.5%, choline chloride 0.08%, potassium chloride 0.11%, amino acids 4.46% (Arg 0.805%, Gly 0.601%, His 0.143%, Ile 0.507%, Lys-HCl 0.799%, Met 0.444%, Thr 0.517%, Trp 0.133%, Val 0.513%), agar 9.6%

(metabolizable energy 3.2 kcal/g, crude protein 11.7%, leucine 0.763%)

Feed 2: maize 75.7%, wheat bran 0.7%, soybean oil 5.2%, calcium carbonate 1.4%, calcium hydrogen phosphate 1.7%, sodium chloride 0.3%, vitamin-mineral mixture 0.5%, choline chloride 0.08%, potassium chloride 0.11%, amino acids 4.79% (Arg 0.805%, Gly 0.601%, His 0.143%, Ile 0.507%, Lys-HCl 0.799%, Met 0.444%, Thr 0.517%, Trp 0.133%, Val 0.513%, Leu 0.327%), agar 9.48%

(metabolizable energy 3.2 kcal/g, crude protein 12.0%, leucine 1.09%)

Feed 3: maize 75.7%, wheat bran 0.7%, soybean oil 5.0%, calcium carbonate 1.4%, calcium hydrogen phosphate 1.7%, sodium chloride 0.3%, vitamin-mineral mixture 0.5%, choline chloride 0.08%, potassium chloride 0.11%, amino acids 5.12% (Arg 0.805%, Gly 0.601%, His 0.143%, Ile 0.507%, Lys-HCl 0.799%, Met 0.444%, Thr 0.517%, Trp 0.133%, Val 0.513%, Leu 0.654%), agar 9.36%

(metabolizable energy 3.2 kcal/g, crude protein 12.2%, leucine 1.42%)

Feed 4: maize 75.7%, wheat bran 0.7%, soybean oil 4.9%, calcium carbonate 1.4%, calcium hydrogen phosphate 1.7%, sodium chloride 0.3%, vitamin-mineral mixture 0.5%, choline chloride 0.08%, potassium chloride 0.11 %, amino acids 5.33% (Arg 0.805%, Gly 0.601%, His 0.143%, Ile 0.507%, Lys-HCl 0.799%, Met 0.444%, Thr 0.517%, Trp 0.133%, Val 0.513%, Leu 0.872%), agar 9.29%

(metabolizable energy 3.2 kcal/g, crude protein 12.3%, leucine 1.64%)

After slaughter, the free glutamic acid content per 1 g of meat was determined by a conventional method (described in (1) Effect of Restricted Feeding before Marketing on Taste Active Components of Broiler Chickens, Shinobu FUJIMURA, Fumiaki SAKAI, Motoni KADOWAKI, Animal Science Journal, 72(3), P223-229, 2001; (2) Shinobu FUJIMURA, Katsumi NISHIFUJI, Naoyuki MORI, Hiromi SUZUKI, Akie YAMAUCHI, Naoto HARADA, Naoko HASHIGUCHI, Shiro IMAI, Yumiko ISHIBASHI, Machiko KIYOKAWA and Keiko HORIGUCHI, “Agriculture & Livestock Industries Corporation, Report on Investigation and Study of Development of Demand of Livestock Products, year 1999”, pp.56-79, 2000, and so on).

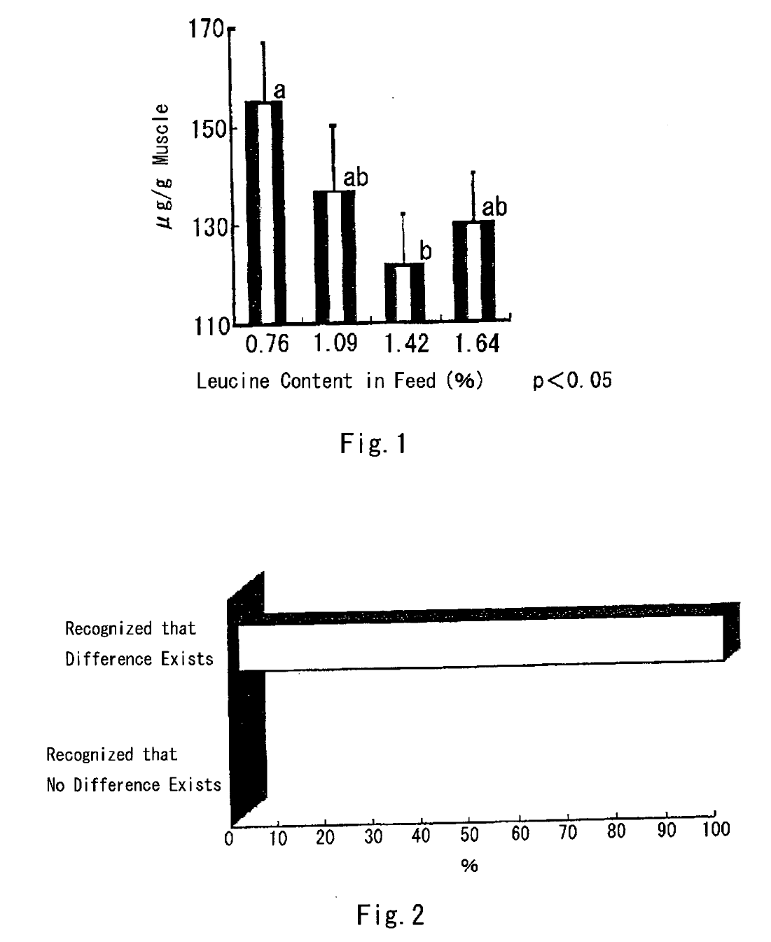

The results are shown in FIG. 1. In FIG. 1, the abscissa indicates the leucine content in the feed, and the ordinate indicates the free glutamic acid level in the muscle. The symbols “a” and “b” indicate significant difference (P<0.05). As shown in FIG. 1, by applying the method of the present invention, the free glutamic acid level in the muscle was higher than those obtained by other methods.

### EXAMPLE 3, COMPARATIVE EXAMPLE 3

Sensory evaluation of the taste of the meats obtained in Example 1 and Comparative Example 1 was performed. The examined meats were the meat of the chickens to which Feed 1 (Example 1) having the leucine content of 0.76% by weight was given and the meat of the chickens to which Feed 3 (Comparative Example 1) having the leucine content of 1.42% by weight was given. The number of panelists was 12, and (1) whether there was a difference between the tastes of the meats was examined by two-point comparison. Further, (2) the characteristics of the tastes of the meats were compared by the Scheffe paired comparison test (References: (1) Sensory Analysis Handbook New Version, Japan Science and Technology Association, Sensory Analysis Committee, Japan Science and Technology Association Publisher, 1973, (2) Effect of Restricted Feeding before Marketing on Taste Active Components of Broiler Chickens, Shinobu FUJIMURA, Fumiaki SAKAI, Motoni KADOWAKI, Animal Science Journal, 72(3), P223-229, 2001).

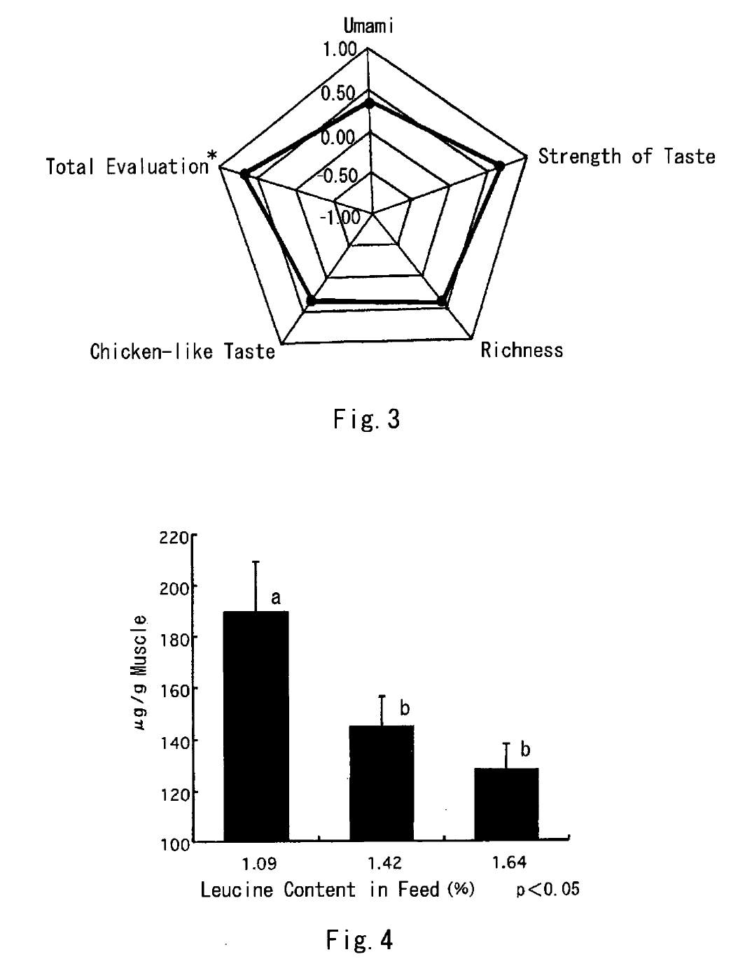

The results are shown in FIGS. 2 and 3. As shown in FIG. 2, all of the panelists recognized that there was a difference in taste. Further, as shown in FIG. 3, the meat obtained by applying the method of the present invention was evaluated as having strong umami, strong taste, and richness, and the total evaluation was significantly better.

### EXAMPLE 4, COMPARATIVE EXAMPLES 4 AND 5

To each group of chickens consisting of 12 chickens per group, Feed 5 (Example 4), Feed 6 (Comparative Example 4) or Feed 7 (Comparative Example 5) was continuously given for 10 days from 4 weeks of age to immediately before the slaughter. The leucine contents of Feed 5, Feed 6 and Feed 7 were 1.09% by weight, 1.42% by weight and 1.64% by weight, respectively. The composition of each feed is shown below.

Feed 5: maize 75.7%, wheat bran 0.7%, soybean oil 2.5%, calcium carbonate 1.4%, calcium hydrogen phosphate 1.7%, sodium chloride 0.3%, vitamin-mineral mixture 0.5%, amino acid mixture 11.2%, choline chloride 0.08%, potassium chloride 0.11%, amino acids 0.93% (Arg 0.352%, Met 0.125%, Thr 0.129%, Leu 0.327%), agar 4.96%

(metabolizable energy 3.2 kcal/g, crude protein 18.2%, leucine 1.09%)

Feed 6: maize 75.7%, wheat bran 0.7%, soybean oil 2.5%, calcium carbonate 1.4%, calcium hydrogen phosphate 1.7%, sodium chloride 0.3%, vitamin-mineral mixture 0.5%, amino acid mixture 11.2%, choline chloride 0.08%, potassium chloride 0.11%, amino acids 1.26% (Arg 0.352%, Met 0.125%, Thr 0.129%, Leu 0.654%), agar 4.63%

(metabolizable energy 3.2 kcal/g, crude protein 18.4%, leucine 1.42%)

Feed 7: maize 75.7%, wheat bran 0.7%, soybean oil 2.5%, calcium carbonate 1.4%, calcium hydrogen phosphate 1.7%, sodium chloride 0.3%, vitamin-mineral mixture 0.5%, amino acid mixture 11.2%, choline chloride 0.08%, potassium chloride 0.11%, amino acids 1.48% (Arg 0.352%, Met 0.125%, Thr 0.129%, Leu 0.872%), agar 4.41%

(metabolizable energy 3.2 kcal/g, crude protein 18.6%, leucine 1.42%)

The results of raising are shown in Table 1.

TABLE 1

| | Leucine Content (%) | | |
|---|---|---|---|
| | | 1.42 (Comparative | 1.64 (Comparative |
| Items | 1.09 (Example 4) | Example 4) | Example 5) |
| Body weight (g) | 1895.1 ± 34.9 | 1928.1 ± 47.4 | 1907.9 ± 50.0 |
| Body weight gain (g/day) | 621.1 ± 29.1 | 629.8 ± 30.5 | 614.6 ± 41.4 |
| Feed intake (g/10days) | 1277.7 ± 55.5 | 1328.8 ± 31.7 | 1259.7 ± 107.3 |
| Feed efficiency (g body weight/g intake) | 0.49 ± 0.01 | 0.47 ± 0.02 | 0.50 ± 0.03 |
| Leucine intake* (g/10days) | 13.9 ± 0.61 | 18.8 ± 0.45 | 20.6 ± 1.76 |
| Energy intake (kcal/11days) | 4111.5 ± 178.7 | 4301.5 ± 102.6 | 4092.8 ± 348.8 |
| Protein intake (g/10days) | 232.8 ± 10.1 | 245.0 ± 5.8 | 234.1 ± 19.9 |
| Breast meat (g) | 123.8 ± 6.0 | 121.6 ± 6.2 | 124.5 ± 5.1 |
| Ratio of breast meat (%, g muscle/g final body weight) | 12.5 ± 0.5 | 12.1 ± 0.5 | 12.5 ± 0.4 |
| Fat percentage in abdominal cavity (%, g fat/g final body weight) | 1.3 ± 0.13 | 1.5 ± 0.11 | 1.3 ± 0.10 |

*p < 0.05

As shown in Table 1, no significant difference was observed between the groups except for the leucine intake. Therefore, it was confirmed that the tests descried below were the tests purely reflecting the influence by leucine.

The free glutamic acid content in the meat of the chickens raised by giving the feed of Example 4, Comparative Example 4 or Comparative Example 5 as described above was measured in the same manner as in Example 1.

The results are shown in FIG. 4. As shown in FIG. 4, the free glutamic acid content in the meat of the chickens raised by giving Feed 5 of Example 4 (leucine content: 1.09%) was significantly higher than those in the meat of chickens raised by giving Feed 6 of Comparative Example 4 (leucine content: 1.42%) or Feed 7 of Comparative Example 5 (leucine content 1.64%). By these results, it was confirmed that the method of the present invention is also effective in the feeds having a high content of proteins.

Further, the tastes of the meat of the chickens raised by giving Feed 5 of Example 4 (leucine content: 1.09%) or Feed 7 of Comparative Example 5 (leucine content: 1.64%) was examined by sensory evaluation by panelists as in Example 3.

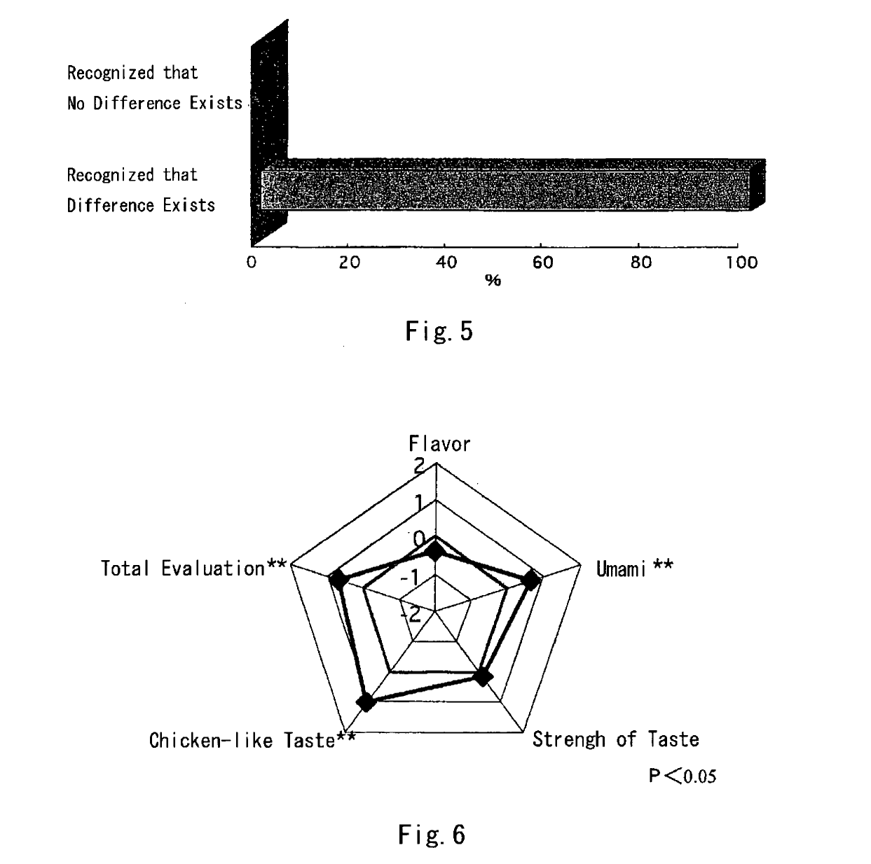

The results are shown in FIGS. 5 and 6. As shown in FIG. 5, all of the panelists recognized that there was a difference in taste. Further, to elucidate the difference in the tastes concretely, the tastes were examined by paired comparison method. As a result, the meat of the chicken raised by giving the feed of Example 4 was significantly better in umami, total evaluation and chicken-like taste.

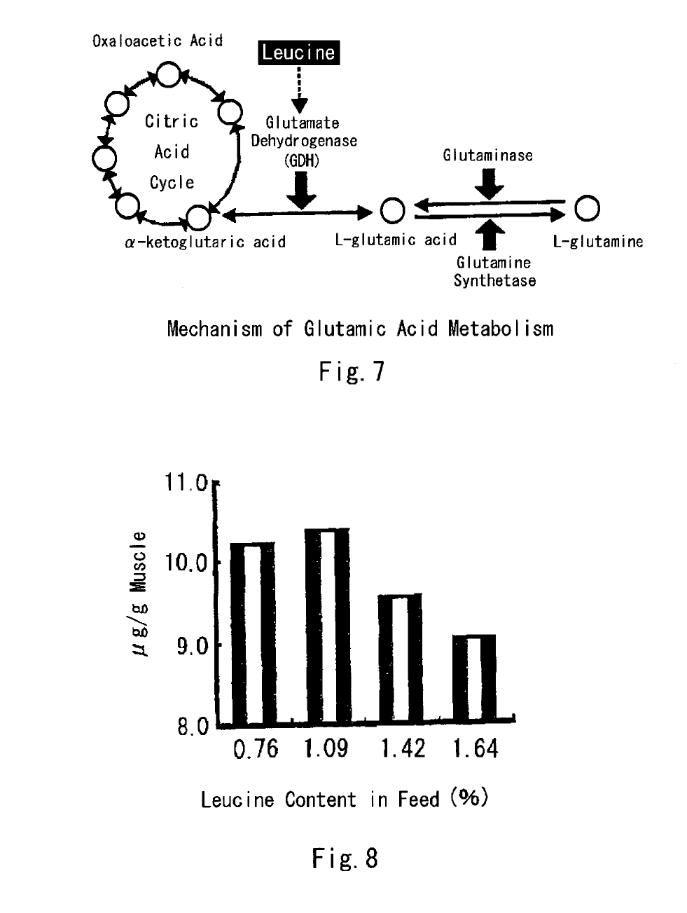

The mechanism of action of the method of the present invention in the animal body is shown in FIGS. 7 and 8. As shown in FIG. 7, glutamate dehydrogenase (GDH) whose substrate is α-ketoglutaric acid influences on the synthesis of glutamic acid in the muscle. GDH shows a high activity at the leucine content of 0.76%, while the activity is decreased at a leucine content of not less than 1.42% and the synthesis capability of glutamic acid is decreased. As a result, glutamic acid level was low with the feeds having a high leucine content.

### INDUSTRIAL AVAILABILITY

By the method of the present invention, free glutamic acid content in the meat can be increased and the taste of the meat can be improved thereby, without deteriorating the raising performance. Therefore, the present invention is expected to greatly contribute to the poultry farming and livestock raising.

1. A method for increasing free glutamic acid content in meat of poultry or livestock, which method comprises giving the poultry or the livestock a feed having a low leucine content.

2. The method according to claim 1, wherein said leucine content is not less than 70% and less than 120% of leucine requirement.

3. The method according to claim 1, wherein said leucine content is not less than 70% and less than 108% of leucine requirement.

4. The method according to any one of claims 1 to 3, wherein said poultry or livestock is chicken.

5. The method according to claim 4, wherein said feed has a leucine content of not less than 0.76% by weight and less than 1.30% by weight in cases where the chicken is not younger than 3 weeks old and younger than 6 weeks old at the time of slaughter, and has a leucine content of not less than 0.65% by weight and less than 1.12% by weight in cases where the chicken is not younger than 6 weeks old at the time of slaughter.

6. The method according to claim 6, wherein said feed has a crude protein content of 17% by weight to 24% by weight, and has a leucine content of 90% to 120% of leucine requirement.

7. The method according to claim 4, wherein said leucine content is not less than 100% and less than 108% of leucine requirement.

8. The feed having a low leucine content used for the method according to any one of claims 1 to 7.
